(19) United States
(12) Patent Application Publication
(10) Pub. No.: US 2005/0189190 A1
(43) Pub. Date: Sep. 1, 2005

(54) Electrohydraulic clutch assembly

(76) Inventors: Christopher J. Kowalsky, Windsor (CA); Mark A. Perlick, Shelby Township, MI (US); Andy Yu, Saline, MI (US); Larry Pritchard, Macomb, MI (US)

Correspondence Address: BORGWARNER INC., PATENT DEPARTMENT, 3850 HAMLIN ROAD, AUBURN HILLS, MI, 48326-2872, US

(21) Appl. No.: 10/788,621

(22) Filed: Feb. 27, 2004

(51) Int. Cl. F16D 28/00

(52) U.S. Cl. 192/20; 192/84.6

(57) ABSTRACT

An electrohydraulic clutch includes a bi-directional electric motor, a hydraulic circuit and a multiple plate friction clutch pack. The bi-directional electric motor drives a ball screw through a gear reduction assembly. The ball screw output translates a master piston of the hydraulic circuit which in turn advances and retracts an annular sleeve piston disposed adjacent the friction clutch pack. Hence, actuation of the electric motor displaces hydraulic fluid and compresses or relaxes the friction clutch pack, thereby transferring or inhibiting torque.

### BACKGROUND OF THE INVENTION

The invention relates generally to an electrohydraulic clutch and more specifically to an electrohydraulic clutch having an electric motor, a hydraulic fluid circuit and a multiple plate friction clutch pack.

Clutches which are activated or energized by electromagnetic coils are extraordinarily common components in rotary power transmission systems, both in stationary applications and in motor vehicles. Such electromagnetic clutches may be broadly characterized by whether they provide on-off energy transfer or modulating energy transfer. In the case of the former, dog clutches which may include auxiliary synchronizing devices are utilized whereas in the latter, friction clutch packs having a plurality of interleaved friction plates or discs are utilized. In either case, an electromagnetic operator which translates or compresses components of the clutch upon energization activates the clutch and upon deenergization deactivates or relaxes the clutch.

One of the design and operational characteristics of electromagnetic clutches which receives significant engineering attention is power consumption. It is desirable, especially in motor vehicles, to design and utilize a clutch having low power consumption. Low power consumption is desirable in and of itself but it also reduces the heat generated by the coil and thus lower power consumption can reduce the need for cooling the coil, can improve the service life of the coil and is therefore overall a desirable design goal.

Another design consideration may be broadly characterized as control. It is desirable for motor vehicle drive line clutches to both engage smoothly and preferably imperceptibly and also modulate accurately in proportion to the control signal, that is, exhibit close correspondence between the magnitude of the electrical drive signal (representing the desired proportion of clutch engagement) and the actual clutch engagement.

The present invention is directed to these design goals.

### SUMMARY OF THE INVENTION

An electrohydraulic clutch includes a bi-directionally rotatable electric motor, a hydraulic circuit and a multiple plate friction clutch pack. The electric motor drives a ball screw through a multiple gear speed reduction assembly. The ball screw output translates a master piston of the hydraulic circuit which in turn advances and retracts an annular slave piston disposed adjacent the friction clutch pack. Hence, actuation of the electric motor displaces hydraulic fluid and compresses or relaxes the friction clutch pack. An anti-back drive assembly disposed between the motor and gear reduction assembly includes a wrap spring disposed between two hubs and contained within a cylindrical aperture or housing.

It is thus an object of the present invention to provide an electrohydraulically actuated friction clutch.

It is a further object of the present invention to provide an electrohydraulic clutch including a multiple plate friction clutch assembly.

It is a still further object of the present invention to provide an electrohydraulic clutch having an electric motor and anti-back drive assembly.

It is a still further object of the present invention to provide an electrohydraulic clutch for use in transfer cases, rear axles and other motor vehicle drive line components.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a diagrammatic view of a four-wheel drive motor vehicle power train having an electrohydraulic clutch assembly according to the present invention utilized in conjunction with a rear differential;

FIG. 2 is a full, sectional view of an electrohydraulic clutch assembly according to the present invention taken along line 2-2 of FIG. 1; and

FIG. 3 is a full, sectional view of an electrohydraulic clutch assembly according to the present invention taken along line 3-3 of FIG. 1.

### DETAILED DESCRIPTION OF THE PREFERRED EMBODIMENT

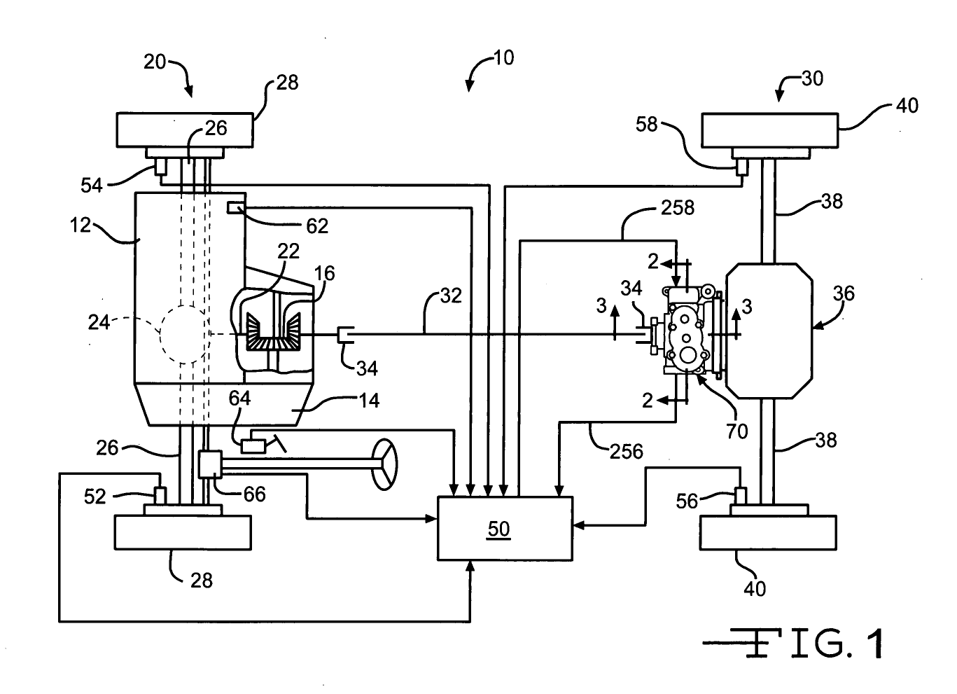

Referring now to FIG. 1, a four-wheel vehicle drive train incorporating the present invention is diagrammatically illustrated and designated by the reference number 10. The four-wheel vehicle drive train 10 includes a prime mover 12 such as an internal combustion gas or Diesel engine or hybrid power plant which is coupled to and directly drives a transaxle 14. The output of the transaxle 14 drives a bevel or spiral bevel gear set 16 which provides motive power to a primary or front drive line 20 comprising a front or primary propshaft 22, a front or primary differential assembly 24, a pair of live front axles 26 and a respective pair of front or primary tire and wheel assemblies 28. It should be appreciated that the front or primary differential 24 is conventional.

The bevel or spiral bevel gear set 16 also provides motive power to a secondary or rear drive line 30 comprising a secondary propshaft 32 having appropriate universal joints 34, a rear or secondary differential assembly 36, a pair of live secondary or rear axles 38 and a respective pair of secondary or rear tire and wheel assemblies 40.

The foregoing description relates to a vehicle wherein the primary drive line 20 is disposed at the front of the vehicle and, correspondingly, the secondary drive line 30 is disposed at the rear of the vehicle, such a vehicle commonly being referred to as a front wheel drive vehicle or adaptive front wheel drive vehicle. The designations “primary” and “secondary” utilized herein refer to drive lines providing drive torque at all times and drive lines providing supplemental or intermittent torque, respectively. These designations (primary and secondary) are utilized herein rather than front and rear inasmuch as the invention herein disclosed and claimed may be readily utilized with vehicles wherein the primary drive line 20 is disposed at the rear of the vehicle and the secondary drive line 30 and components within the secondary differential assembly 36 are disposed at the front of the vehicle.

Thus, the illustration of FIG. 1, wherein the primary drive line 20 is disposed at the front of the vehicle should be understood to be illustrative rather than limiting and that the components and the general arrangement of components illustrated is equally suitable and usable with a primary rear wheel drive vehicle.

Associated with the vehicle drive train 10 is a controller or microprocessor 50 which receives signals from a plurality of sensors and provides a control, i.e., actuation, signal to an electrohydraulic clutch assembly 70 operably disposed before the secondary differential assembly 36. Specifically, a first sensor such as a Hall effect or variable reluctance sensor 52 senses the rotational speed of the left primary (front) tire and wheel assembly 28 and provides an appropriate signal to the microprocessor 50. Similarly, a second variable Hall effect or variable sensor 54 senses the rotational speed of the right primary (front) tire and wheel assembly 28 and provides a signal to the microprocessor 50. A third Hall effect or variable reluctance sensor 56 senses the rotational speed of the left secondary (rear) tire and wheel assembly 40 and provides a signal to the microprocessor 50. Finally, a fourth Hall effect or variable reluctance sensor 58 associated with the right secondary (rear) tire and wheel assembly 40 senses its speed and provides a signal to the microprocessor 50. It should be understood that the speed sensors 52, 54, 56 and 58 may be independent, i.e., dedicated, sensors or may be those sensors mounted in the vehicle for anti-lock brake systems (ABS) or other traction control or stability systems. It should also be understood that an appropriate and conventional counting or tone wheel is associated with each of the speed sensors 52, 54, 56 and 58 although they are not illustrated in FIG. 1.

The controller or microprocessor 50 may also receive information from other sensors regarding vehicle operating variables and conditions. For example, an engine speed sensor 62 may be utilized to provide a real time signal to the microprocessor 50 regarding the speed of the engine 12. Additionally, a throttle position sensor 64 may be included to provide a real time signal to the microprocessor 50 regarding the degree or extent of activation of the accelerator pedal. Furthermore, a steering angle sensor 66 may be utilized to provide real time data to the microprocessor 50 regarding the angular position of the steering column, the lateral position of the steering rack or the angular position of the front tire and wheel assemblies 28. The controller or microprocessor 50 includes software which receives and conditions the signals from the sensors 52, 54, 56 and 58 as well as the optional sensors 62, 64 and 66, determines corrective action to improve the stability of the vehicle, maintain control of the vehicle and/or correct or compensate for a skid or other anomalous operating condition and provides an output signal to the electrohydraulic clutch assembly 70.

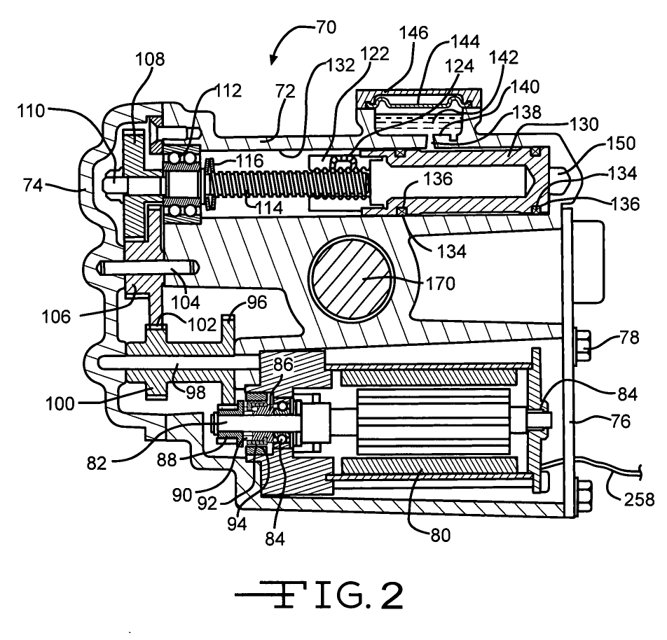

Referring now to FIG. 2, the electrohydraulic clutch assembly 70 includes a preferably metal housing 72 having various bores, ports, slots, faces, passageways and the like which receive the various components thereof. A first end plate 74 is especially formed to receive various shafts, fits tightly on one end face of the housing 72 and is secured thereby a plurality of fasteners (not illustrated). A second end plate 76 is secured to the other end face of the housing 72 by a plurality of fasteners 78. Disposed within a suitably sized region of the housing 72 is a bi-directional, fractional horsepower electric motor 80. The electric motor 80 includes an output shaft 82 which is supported upon suitable bearings 84 and includes a drive hub 86 having a diametric vane. A driven pinion gear 88 which is freely rotatably disposed on the output shaft 82 includes two-axially extending lugs 90. The lugs 90 engage opposite sides or faces of the vaned drive hub 86 thus allowing limited (approximately 1500 to 1600) angular relative rotation between the vaned drive hub 86 and the pinion gear 88. A wrap spring 92 is wrapped about and extends between the vaned drive hub 86 and the lugs 90 and the pinion gear 88.

The wrap spring 92 is received within a relatively closely fitting cylindrical aperture or passageway 94 which may be formed in the housing 72 or may be a bore or passageway in a stationary collar or similar component. The wrap spring 92, the associated drive hub 86 and the pinion gear 88 cooperate to accommodate bi-directional drive of the pinion gear 88 by the motor 80 as the lugs 90 engage and thus achieve direct drive of the pinion gear 88 by the vaned drive hub 86. However, when electrical power to the electric motor 80 is terminated, and forces attempt to back drive the electric motor 80, the wrap spring 92 is unwound by rotation of the pinion gear 88. As the wrap spring 92 is unwound and expands, it engages the surface or wall of the aperture or passageway 94 thus inhibiting further reverse rotation of the pinion gear 88.

The pinion gear 88 is in constant mesh with a first spur gear 96. The first spur gear 96 is supported upon a first shaft 98 and is coupled to or integrally formed with a smaller diameter second pinion gear 100 which is in constant mesh with a second spur gear 102. The second spur gear 102 is likewise rotatably supported upon a second stub shaft 104. The second spur gear 102 is coupled to or preferably integrally formed with a third pinion gear 106. The third pinion gear 106 is in constant mesh with and drives a third spur gear 108 which is secured to a drive shaft 110.

The drive shaft 110 is preferably supported by a pair of anti-friction bearings such as roller bearing assemblies 112. The drive shaft 110 includes a ball screw portion 114. Between the drive shaft 110 and the ball screw portion 114 are mounted a plurality of Belleville springs or washers 116 that function as a resilient stop. Disposed about the ball screw portion 114 is a recirculating ball nut 122. The recirculating ball nut 122 includes a plurality of balls or roller bearings 124 which recirculate about the complementarily configured grooves in the ball screw 114 and thus provide a low friction interconnection between the ball screw 114 and the nut 122. As the shaft 110 bi-directionally rotates in response to bi-directional rotation of the output shaft 84 of the electric motor 80, the recirculating ball nut 122 translates to the left and right. The ball screw 114 and the recirculating ball nut 122 thus function as a rotary to linear motion transducer.

The recirculating ball nut 122 is coupled to a master piston 130 which translates axially within an elongate cylinder 132 which also contains the lead screw portion 114. The master piston 130 includes a pair of O-ring seals 134 which are received within suitably configured circumferential grooves 136 near each end of the piston 130. The master piston 130 is shown in FIG. 2 in its fully advanced or extended position. As the master piston 130 is retracted by rotation of the ball screw 114, it passes a port 138 which communicates with a fluid reservoir 140. The fluid reservoir 140 is preferably maintained substantially full of a hydraulic fluid 142 such that the cylinder 132 may be fully filled with hydraulic fluid when the piston 130 is retracted. A flexible seal 144 accommodates changes in volume of the hydraulic fluid 142 and a metal plate or cap 146 secures the flexible seal 144 and maintains a fluid tight seal thereabout. The cylinder 130 narrows to a first fluid passageway 150 which provides for communication and flow of the hydraulic fluid 142 to the driven components of the electrohydraulic clutch assembly 70.

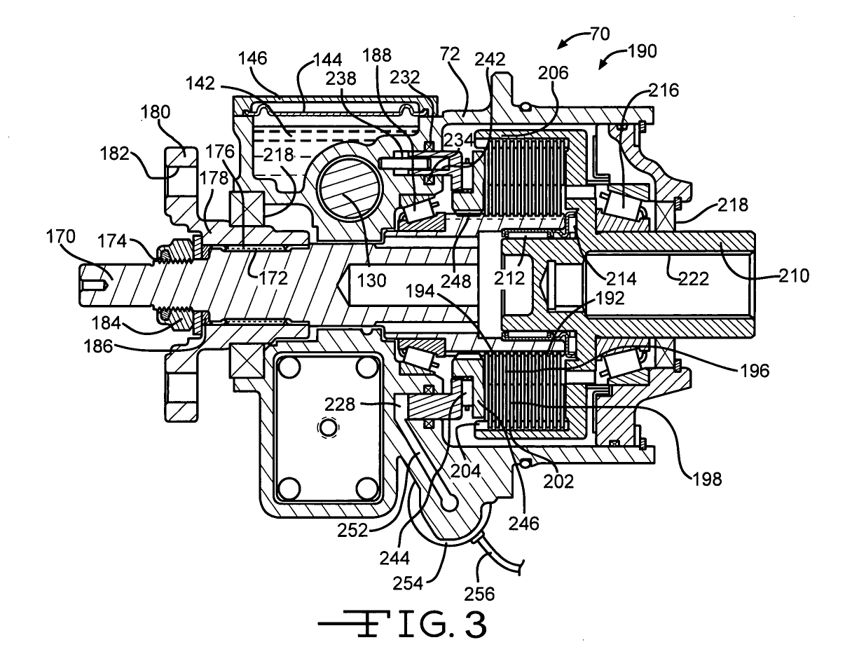

Turning now to FIG. 3, the electrohydraulic clutch assembly 70 includes an input shaft 170 preferably including a set of external or male splines or gear teeth 172 and a smaller diameter threaded region 174. The male or external splines or gear teeth 172 are engaged by complementarily configured female splines or gear teeth 176 formed on the interior of a cylindrical region 178 of a flange 180. The flange 180 preferably includes a plurality of through apertures 182 which may receive threaded fasteners or other components (not illustrated) associated with a drive component to the electrohydraulic clutch assembly 70 such as a universal joint 34, illustrated in FIG. 1. A retaining nut 184 as well as one or more flat washers 186 may be utilized to positively retain the flange 180 upon the input shaft 170. A tapered roller bearing assembly 188 rotatably supports the input shaft 170 within the housing 72 of the electrohydraulic clutch assembly 70.

The electrohydraulic clutch assembly 70 also includes a multiple plate friction clutch pack assembly 190. Driving the friction clutch pack assembly 190 are a plurality of male or external splines or teeth 192 disposed on the input shaft 170 which engage complementarily configured female spines 194 on a first plurality of smaller diameter friction clutch plates or discs 196. The first plurality of friction clutch plates or discs 196 are interleaved with a second plurality of larger diameter friction clutch plates or discs 198. The friction clutch plates or discs 196 and 198 include suitable clutch paper or friction material in accordance with conventional practice. Each of the second plurality of larger diameter friction clutch plates or discs 198 includes male or external splines 202 which engage and drive complementarily configured female or internal splines 204 formed on the interior of a cylindrical portion 206 of an output shaft 210. The output shaft 210 is rotationally isolated from and stabilized within a portion of the input shaft 170 by a roller bearing assembly 212. A thrust bearing assembly 214 is also disposed between the input shaft 170 and the output shaft 210 which is further supported by a tapered roller bearing assembly 216. Suitable oil seals 218 prevent the ingress of foreign matter and maintain a fluid tight seal between the housing 72, the input shaft 170 and the output shaft 210.

The output shaft 210 preferably includes internal or female splines or gear teeth 222 which are complementary to and engage suitably configured male splines or gear teeth (not illustrated) disposed within the rear differential assembly 36 which receive torque from the electrohydraulic clutch assembly 70.

The first fluid passageway 150 illustrated in FIG. 2 communicates with a cylinder 228 which receives an annular slave piston 230. A first outer O-ring 232 and a second inner O-ring 234 disposed within suitable circular grooves provide a fluid tight seal against the side walls of the annular slave piston 230. A register pin 238 seats within a complementarily configured blind aperture 242 in the annular slave piston 230 and inhibits rotation of the annular piston 230 within the cylinder 228. The annular piston 230 engages a thrust bearing 244 which permits relative rotation between the annular piston 230 and a circular apply plate 246. The circular apply plate 246 transfers axial motion and force generated by the piston 230 to the friction clutch pack assembly 190. The apply plate 246 includes female or internal splines 248 which are complementary to and engage the male splines 192 on the input shaft 170. Thus, the apply plate 246 rotates with the input shaft 170.

A second fluid passageway 252 provides communication between the cylinder 228 and a fluid pressure sensor or transducer 254. The pressure fluid sensor or transducer 254 is preferably a piezoelectric device which provides a signal in a single or multiple conductor cable 256 to the microprocessor 50 regarding the real time hydraulic fluid pressure within the cylinder 228. Electrical energy is provided to the electric motor 80 through a single or multiple conductor cable 258 illustrated in FIGS. 1 and 2.

The operation of the electrohydraulic clutch assembly 70 will now be described with reference to all the drawing figures. As noted, signals are preferably provided by the wheel speed sensors, 52, 54, 56 and 58 and the other sensors 62, 64 and 66 to the microprocessor 50. The microprocessor 50 provides a signal in the cable 258 to the electric motor 80 commanding it to rotate in one of two directions to increase or decrease the pressure of the hydraulic fluid 142 and thus the torque transferred through the friction clutch pack assembly 190. If the command from the microprocessor 50 is to increase torque throughput, the electric motor 80 rotates in a direction to advance the recirculating ball nut 122 and advance the master piston 130 within the elongate cylinder 132. As the master piston 130 translates, hydraulic fluid 142 is transferred, its pressure increases and the annular slave piston 230 translates, compressing the friction clutch pack assembly 190. A command from the microprocessor 50 to reduce torque transferred through the friction clutch pack assembly 190 results in the opposite action.

As noted above, the wrap spring 92 inhibits back driving of the electric motor 80 by the hydraulic pressure exerted on the piston 130 and the lead screw portion 114. This is achieved, as also noted above, by the expansion of the wrap spring 92 and grounding or contact with the surface of the cylindrical aperture or passageway 94 as it is driven in a direction which both unwinds it and corresponds to retraction of the piston 130. The prevention of back driving and thus the maintenance of a given pressure of the hydraulic fluid 142 and corresponding torque delivery through the friction clutch pack assembly 190 allows the electric motor 80 to be de-energized after it has achieved a desired position and fluid pressure thereby conserving electrical power. In this regard, it should also be noted that the pressure transducer 254 provides information to the microprocessor 50 regarding the current, actual pressure of the hydraulic fluid 142 which corresponds to a level of torque throughput. Such information may be utilized by the microprocessor 50 to adjust, in real time, the electrical energy delivered to the electric motor 80 to achieve a desired torque throughput.

Finally, it should be noted that the design of the housing 72 as well as the arrangement of components provides a passive oiling or lubrication system to the various components within the electrohydraulic clutch assembly 70. Thus, not only is the need for specific lubricating means such as a pump avoided but the assembly exhibits improved durability and service life.

The foregoing disclosure is the best mode devised by the inventors for practicing this invention. It is apparent however, that devices incorporating modifications and variations will be obvious to one skilled in the art of electrohydraulic clutch assemblies. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

1. An electrohydraulic clutch assembly comprising, in combination,
an input member and a coaxially disposed output member,
a bi-directional electric motor,
a gear train having an input driven by said electric motor and an output,
a ball screw driven by said output and driving a first piston displacing hydraulic fluid,
a second piston translated by said hydraulic fluid, and
a friction clutch pack operably disposed between said input member and said output member and actuated by said second piston.

2. The electrohydraulic clutch assembly of claim 1 further including means for inhibiting back driving of said electric motor.

3. The electrohydraulic clutch assembly of claim 2 wherein said inhibiting means includes a wrap spring disposed within a cylindrical passageway and extending between a drive hub and a driven pinion.

4. The electrohydraulic clutch assembly of claim of 1 further including a pressure sensor for providing a signal representing a pressure of hydraulic fluid generated by said first piston.

5. The electrohydraulic clutch assembly of claim 1 further including a microprocessor having an output adapted to bi-directionally drive said electric motor.

6. The electrohydraulic clutch assembly of claim 1 wherein said friction clutch pack includes a first plurality of clutch plates coupled to said input member and a second plurality of clutch plates interleaved with said first plurality of clutch plates and coupled to said output member.

7. The electrohydraulic clutch assembly of claim 1 further including a circular apply plate and a thrust bearing both disposed between said second piston and said friction clutch pack.

8. An electrohydraulic clutch assembly comprising, in combination, an input member and a coaxially disposed output member,
an electric motor,
a master piston,
a rotary motion to linear motion transducer operably driven by said electric motor and driving said master piston,
a friction clutch pack operably disposed between said input member and said output member, and
a slave piston in fluid communication with said master piston and acting upon said friction clutch pack.

9. The electrohydraulic clutch assembly of claim 8 further including means for inhibiting back driving of said electric motor.

10. The electrohydraulic clutch assembly of claim 9 wherein said inhibiting means includes a wrap spring disposed within a cylindrical passageway and extending between a drive hub and a driven pinion.

11. The electrohydraulic clutch assembly of claim of 8 further including a pressure sensor for providing a signal representing a pressure of hydraulic fluid generated by said master piston.

12. The electrohydraulic clutch assembly of claim 8 further including a microprocessor having an output for bi-directionally driving said electric motor.

13. The electrohydraulic clutch assembly of claim 8 wherein said friction clutch pack includes a first plurality of clutch plates coupled to said input member and a second plurality of clutch plates interleaved with said first plurality of clutch plates and coupled to said output member.

14. The electrohydraulic clutch assembly of claim 8 further including a circular apply plate and a thrust bearing both disposed between said slave piston and said friction clutch pack.

15. An electrohydraulic clutch assembly for motor vehicle drivelines, comprising, in combination,
a bi-directional electric motor,
a gear train having in input driven by said electric motor and an output,
a ball screw assembly driven by said output of said gear train,
a first piston bi-directionally translated by said ball screw assembly,
a second piston in fluid communication with said master piston and,
a friction clutch pack having an input and an output and acted upon by said second piston.

16. The electrohydraulic clutch assembly of claim 15 further including means for inhibiting back driving of said electric motor.

17. The electrohydraulic clutch assembly of claim 16 wherein said inhibiting means includes a wrap spring disposed within a cylindrical passageway and extending between a drive hub and a driven pinion.

18. The electrohydraulic clutch assembly of claim 17 wherein said inhibiting means includes a wrap spring disposed within a cylindrical passageway and extending between a drive hub and a driven pinion, wherein said drive hub and said driven pinion including a coupling accommodating limited relative rotation.

19. The electrohydraulic clutch assembly of claim of 15 further including a pressure sensor for providing a signal representing a pressure of hydraulic fluid generated by said master piston.

20. The electrohydraulic clutch assembly of claim 15 further including a microprocessor having an output adapted to bi-directionally drive said electric motor.

21. The electrohydraulic clutch assembly of claim 15 wherein said friction clutch pack includes a first plurality of clutch plates coupled to said input member and a second plurality of clutch plates interleaved with said first plurality of clutch plates and coupled to said output member.

22. The electrohydraulic clutch assembly of claim 15 wherein said output of said friction clutch pack provides drive torque to a differential in a motor vehicle driveline.

23. The electrohydraulic clutch assembly of claim 15 further including a circular apply plate and a thrust bearing both disposed between said second piston and said friction clutch pack.
